(19) United States
(12) Patent Application Publication
(10) Pub. No.: US 2004/0051888 A1
(43) Pub. Date: Mar. 18, 2004

(54) Color management with reference gamut

(75) Inventor: Peter Zolliker, Dielsdorf (CH)

Correspondence Address: BURNS, DOANE, SWECKER & MATHIS, L.L.P., P.O. Box 1404, Alexandria, VA, 22313-1404, US

(73) Assignee: Imaging Solutions AG

(21) Appl. No.: 10/455,728

(22) Filed: Jun. 6, 2003

(30) Foreign Application Priority Data
Jun. 6, 2002 (EP) 02 012 379.0

(51) Int. Cl. H04N 1/60

(52) U.S. Cl. 358/1.9; 358/518; 382/167

(57) ABSTRACT

Process for the color management of image data which represent the color values of an image, in order to achieve an optimal change of the color values with respect to different and preselected color gamuts of an input device, especially a film scanner or digital camera and an output device, especially a photographic printer or a photolab, whereby an input color gamut includes all color values which can be captured by the input device and output as image data, and an output color gamut includes all color values which can be processed by the output device upon input of image control data into the output device. The process provides for receiving image data which represent first positions in a first color space and describe first color values, which are located within the input color gamut; transforming the first positions by an input transformation into reference positions, whereby the transformation is designed such that the reference positions are located in a second color space and describe second color values, whereby a reference color gamut defines the color values reproducible by the reference positions. The reference positions can be transformed by an output transformation into third positions, whereby the output transformation is designed such that the third positions are located in a third color space and describe third color values, whereby all color values come to be located in an output color gamut which includes the possible color control values of the output device.

### RELATED APPLICATIONS

This application claims priority under 35 U.S.C. §119 to a European Application 02 012 379.0 filed in Europe on Jun. 6, 2002, the entire contents of which are hereby incorporated by reference in their entirety.

### BACKGROUND

1. Field

The present invention relates to the processing of picture data to achieve as much as possible an optimal color reproduction. The invention relates in particular to the field of photography, which means the image data particularly represent photographic pictures such as those captured by picture capturing devices, such as photographic cameras, video cameras, digital cameras, scanners, etc. The image data are used for the control of picture reproduction systems, such as for example photographic printers, photolabs, minilabs, color laser printers, ink jet printers, monitors (liquid crystal displays and CRT monitors) and so on. The present invention is used for improving the color impression of pictures, which are reproduced by the picture reproduction system, for example, on a medium (paper, photographic paper, foil, etc.) or screen (monitor). The invention is especially directed to the matching of the color space (input gamut) which can be captured and/or output by an input device (a picture capturing device, for example a scanner, digital camera, etc.) with the color space (output gamut) reproducible by the image reproduction system, when the input gamut does not match the output gamut. The present invention also relates to the processing of image data captured by an input device and present in a device dependent color space, so that they can be output as optimally as possible by an image reproduction system which also defines a device dependent color space.

### BACKGROUND INFORMATION

The processing of sRGB image data represents an example for the above described field of use of the present invention, which image data are, for example, output by a digital camera and processed by an image reproduction system (for example a photographic printer or minilab) so that the picture, which is represented by the image data can be produced with a photographic paper.

The sRGB color space and its connection, for example, with the XYZ color space is described, for example, in “The Creation of the sRGB ICC Profile” by Mary Neilson and Michael Stokes, Hewlett Packard Company, Boise Id., U.S.A., in Color Research No. 568, pp 253-257, 1998. The sRGB color space is especially popular for the following reasons:

The transfer function and the chromaticity of the primary phosphorous colors of cathode ray tubes (CRT monitors) are very similar to the sRGB color space. Thus, images can be shown at reasonable quality on monitors without the need for the mapping of the colors by way of a profile. The sRGB color space is by now so common that even in fields of technology with transfer functions that strongly deviate from sRGB, such as, for example, LCD monitors or plasma monitors, the image data input through an sRGB interface is still supported.

The manufacturers of digital scanners, monitors and digital cameras often provide as further feature of their devices that they output sRGB image data.

Almost all computer programs which are commercially available support sRGB-like color spaces.

Unfortunately, the sRGB color space and the color space of photographic paper (for example silver halogenide paper) are significantly different (see FIG. 1). Wide regions of the sRGB color space, especially the bright, saturated colors, are far outside the gamut of the photographic paper. Conversely, a monitor normally fails to reproduce the dark colors of the photographic paper. Color spaces of inkjet and color laser printers also significantly differ from the sRGB color space.

It is the subject of the color management to match device dependent color spaces to one another. Conventionally, each device or each apparatus has its own color profile. The connection between input and output profiles is carried out in the color management preferably by way of a color space which is independent of the input and output devices. This color space is also called profile connection space or PCS. Input and output devices generally have a different gamut. The final mental concept of the color management is described, for example, in the article “Color Management: Current Practice and the Adoption of a New Standard” by Michael Has and Todd Newman, which can be called up at the internet address http://www.color.org/wpaper1.html. In the fundamental concept, which is called colorimetric match, the colors in both gamuts, as far as possible, are transferred while maintaining the color value. Colors which cannot be produced by a certain output device, are mapped onto the gamut boundary. The term “absolute rendering intent” is used for this process. Compromises with respect to the colorimetric matching are normally made in order to match the white point of the two devices or apparatus (“relative rendering intent”). Additionally, further matchings can be carried out especially by also matching the darkest gray tones of the two devices (“perceptual rendering intent”). Such a color management system and its standardization (ICC) is used in the printing industry. The adoption of this intent for the photo finishing industry results however in several disadvantages:

several components of the photo finishing system are insufficiently stable with respect to an exact color reproduction. This is the case, for example, with a photo paper processor, the stability of which often does not satisfy the requirements of a classic color management system. Or the information on the color profile of the input device, for example the film, is not known with sufficient precision or can often change.

The output devices use only those colors, which are common to the output and input devices. The full potential of the output device is therefore not used. However, the inventors have recognized that especially in the photographic area, the customer perceives the color impression of an image as more pleasant or positive when the image reproduction is carried out with more colors, i.e. better uses the color potential of the output device. This pleasing impression is for the customer more important than a colorimetric exact reproduction of the image data, as is the case in the printing industry.

In those regions of the color space of the input device in which the color values must be subjected to a stronger change in order to fit the gamut of the output device, the details of color transitions and color nuances are lost.

If digital data are obtained from a film negative or by the scanning of color pictures and output in digital form, for example as a CD, color information is lost, since the gamut of the film negative or the printout or prints normally does not correspond with the gamut of the scanner. Thus, the output format of the scanner is normally sRGB. If in a following step reprints or new printouts are to be carried out based on the digital data, the results obtained are not the same as if the printout would have been carried out directly, for example, based on a film negative.

The generic realization of color processing modules which are used in color management and, for example, use three-dimensional reference tables (3D-LUT's) often has problems with the precision and the numeric stability in the vicinity of the gamut boundaries, since the gamut mapping carried out thereat causes singular first derivations at the gamut limit.

### SUMMARY OF THE INVENTION

The invention is directed to providing a color management, which can be flexibly adapted to different input devices (image capturing devices) and output devices (image reproduction systems).

The present invention relates to a process for the processing of image data, especially a color management process. The image data represent color values of an image, especially a photographic picture. The color values of the photographic picture, which in particular was captured by an image capturing device, is to be matched by the processing in accordance with the invention to the image reproduction possibilities of an output device, especially an image reproduction system (photographic printer, photolab, monitor, printer, color laser printer, inkjet printer, etc.). The color space manageable by the device is referred to as color gamut of the device. The color gamut of the input device (for example image capturing device) includes all color values, which can be captured and output by the input device. The image data output by the input device, which are processed by the process in accordance with the invention therefore reflect the color gamut of the input device, which especially captures and/or processes photographic information. The image data received by the process in accordance with the invention can be received in different ways, especially through data carriers, such as, for example, CD, networks, internet or through direct connection to an image capturing device such as, for example, a scanner or a digital camera, etc. The image data input into the process are to be processed by the process in accordance with the invention in such a way that the image data output by the process represent color values which are better matched to the color gamut of the output device than the image data input into the process. The color gamut of the output device, i.e. the so-called output color gamut preferably includes all color values, which can be processed (for example reproduced, stored and/or transmitted) by the output device upon input of image data into the output device.

The image data can be two-dimensional as is conventional or three-dimensional (for example holograms).

The image data received by the process in accordance with the invention represent so-called first positions in a first color space and describe first color values. These color values have the property that they lie within the input color gamut.

According to the process in accordance with the invention, the first positions are in a first step transformed by an input transformation into second positions, which are referred to as reference positions. The input transformation is preferably carried out in such a way that the reference positions are present in a second color space. Thus, a transformation from a first color space into a second color space occurs. The first and second color spaces are preferably different. The first color space is especially a device dependent color space of the input device and the second color space is a device independent color space, such as, for example, CIE Lab or XYZ.

In a second step, the reference positions are transformed by an output transformation into third positions. The transformation is preferably carried out such that the third positions are in a third color space. Thus, a transformation of the reference color space into a third color space occurs. The second color space and the third color space are preferably different. The third color space is especially a device dependent color space, which is preferably matched to the output device (for example and RGB color space). Preferably at least either the first or the third color space is different from the second color space. At least a part of the first positions and/or first color values is preferably different from the second positions and/or second color values. At least a part of the third positions and/or the third color values is preferably different from the second positions and/or second color values. At least a part of the first positions or the third positions is preferably different from the second positions. Preferably at least either the input transformation or the output transformation is no identity transformation or at most one of the transformations is an identity transformation. For example, the output transformation can be an identity transformation if the output color gamut corresponds to the reference color gamut. The input transformation can also be an identity transformation if the input color gamut corresponds to the reference color gamut. For example, the output device can be a data recording device or a network interface which can, for example, record or transmit the image data which encompass the reference color gamut. Correspondingly, the input device can be a data reader or a network interface, which, for example, reads out or receives the image data which span the reference color gamut. In this manner, data which represent reference positions can be stored/send and/or read/received. However, the reference color gamut is preferably formed in such a way that it is neither identical with the input color gamut nor the output color gamut.

The input transformation in accordance with the invention can be at least mentally divided into a transformation from the first color space into the second color space (named “first color space transformation”) and into a mapping (named “first mapping”) within the second color space. The color value is thereby preferably not changed upon the transformation from the first to the second color space. The positions resulting from the transformation are in the following referred to as input transformation positions. The mapping then carried out within the second color space can lead at least partially to a color value change. Although this breakdown of the input transformation into a transformation and a mapping is described in the following. This is purely exemplary, since, for example, the first color space transformation and the first mapping within the second color space can be mathematically combined to a single homogeneous input transformation.

The output transformation in accordance with the invention can also be at least mentally divided into a mapping (called “second mapping”) within the second color space and a transformation from the reference color space into the third color space (called “second color space transformation”). The mapping carried out within the second color space can at least partially lead to a color value change. In contrast, the color values preferably not changed during the transformation from the second into the third color space. The positions resulting from the mapping are in the following referred to as output transformation positions, which are then transferred into the third position by the transformation into the third color space. Although the breakdown of the output transformation into an mapping and a transformation is described in the following, that is purely exemplary, since the second mapping within the second color space and the second color space transformation can be mathematically combined, for example, into a single homogeneous output transformation.

Thus, according to the process in accordance with the invention, a matching of the color values to a preselected color gamut, which is referred to as reference color gamut, is carried out, for example, after the aforementioned input transformation into the second color space by the first mapping. This color gamut serves as a “bridge” of “mediation” between the input color gamut and the output color gamut. The reference positions are both with respect to the color space as well as the gamut independent from the input and output device. Thus, not only a color space platform exists, but also a “gamut platform”. The color values represented by the input transformation positions, which preferably correspond to the first color values, are matched within the reference color space to the color reproduction possibilities described by the reference color gamut. This is preferably carried out by way of the first mapping, which maps the input transformation positions in the reference color space onto other positions, which are the above-mentioned reference positions. The reference positions describe the reference color values in the reference color space. The mapping is designed such that the reference color values (also named “second color values”) lie within the reference color gamut or on its boundary. The reference color gamut is preferably designed such that it at least about includes the color values of all considered and predetermined input color gamuts and output color gamuts.

The reference color gamut preferably includes especially in addition to the input color gamut (or in addition to an amalgamated set of a number or plurality of predetermined input color gamuts) at least parts of the output color gamut (or of an amalgamated set of a number or plurality of predetermined output color gamuts) which are not included in the input color gamut (or in an amalgamated set of a number or plurality of input color gamuts), and/or in addition to the output color gamut (or in addition to an amalgamated set or number or plurality of output color gamuts) at least parts of the input color gamut (or an amalgamated set of a number or plurality of predetermined input color gamuts), which are not included in the output color gamut (or the amalgamated set of a number or plurality of predetermined output color gamuts) and especially preferably includes the output color gamut (or the amalgamated set of a number or plurality of predetermined output color gamuts) and the input color gamut (or the amalgamated set of a number or plurality of predetermined input color gamuts) at least approximately. The reference color gamut preferably includes color values from the output color gamut (or the amalgamated set of a number or plurality of predetermined output color gamuts), which are not included in the input color gamut (or the amalgamated set of a number or plurality of predetermined input color gamuts), and/or color values from the input color gamut (or the amalgamated set of a number or plurality of predetermined input color gamuts), which are not included in the output color gamut (or the amalgamated set of a number or plurality of predetermined output color gamuts).

The first mapping within the reference color space is preferably bijectively designed, which means especially no color information is lost.

The third positions are preferably used to determine the image control data which serves the control of the output device which has the output color gamut.

The reference positions then serve preferably as a basis to obtain processed image data, which serve the control of the output device. The output transformation is designed such that the third color values lie within the output color gamut (or on its boundary). Preferably, the second mapping within the reference color space is bijectively designed which means especially no color information is lost.

The input transformation as well as the output transformation are preferably bijectively designed. In that manner, the processing of the image data is reversible, so that no color information is lost even with a long processing chain. Bijective transformations are especially advantageous when data, which are output from an input device, for example a film scanner, on an output device on the one hand, for example a photographic printer, and at the same time intermediately stored on a digital medium such as a CD. When images are later output from this digital medium again on an output device, especially the same output device, it can be ensured that no color information is lost. The transformation during reading from the digital medium (in this function the input device) must correspond to the inverse transformation of the recording (in this function the output device), which requires bijectivity. Thus, in accordance with the invention, the same devices can be used both as input device and as output device.

In accordance with the invention, the input transformation and the output transformation, especially the first mapping and the second mapping within the reference color space are designed according to predetermined marginal conditions and/or properties. Preferably, the reference color values are essentially the same as the first color values, when the first positions (first color values) lie in a predetermined region or part of the first color space and/or when the input transformations and/or reference positions (second color values) lie in a predetermined region or partial space of the reference color space. Especially the second color values are at least essentially the same as the first color values when the first and/or reference color values (also called second color values) represent a medium gray or are in the vicinity thereof. Also, no change or no significant change of the color values occurs, when the color values (which are represented by the first positions and/or reference positions) lie in the inner region (sub-space lying inside, which encompasses especially a medium gray) of the input color gamut and/or the reference color gamut. This inner region is especially distant from the boundary surface of the reference color gamut and/or the input color gamut. The distance is, for example, less than 50, 30 or 10% of the minimum distance to the boundary of the input color gamut and/or the reference color gamut.

The input transformation therefore is preferably carried out position dependent, which means, dependent on the position of the first positions and/or the reference positions.

The first color values which lie on the boundary surface of the input color gamut are mapped by the mapping of the input transformation in the reference color space preferably onto the boundary (boundary surface) of the reference color gamut.

The reference color values are preferably at least essentially the same as the third color values, when the third positions (third color values) lie in a predetermined region or portion of the third color space and/or when the output transformations and/or reference positions (second color values) lie in a predetermined region or partial space of the reference color space. In particular, the reference color values are at least essentially the same as the third color values, when the reference color values and/or third color values represent a medium gray or are in the vicinity thereof. Also, no change or no significant change of the color values occurs, when the color values (which are represented by the third positions and/or reference positions) lie in the inner region (sub-space lying inside, which encompasses especially a medium gray) of the output color gamut and/or the reference color gamut. This inner region is especially distant from the boundary surface of the reference color gamut and/or the input color gamut. The distance is, for example, less than 50, 30 or 10% of the minimum distance to the boundary of the input color gamut and/or the reference color gamut.

The input transformation therefore is preferably carried out position dependent, which means, dependent on the position of the third positions and/or the reference positions.

The reference color values which lie on the boundary surface of the reference color gamut are mapped by the mapping of the output transformation in the reference color space preferably onto the boundary (boundary surface) of the output color gamut.

Preferably, a plastic deformation of the input color gamut through the reference color gamut to the output color gamut is carried out. This deformation, i.e. color value change, as described above, in the central region, especially in the vicinity of the gray axis is preferably formed only little while the extent of the color value change increases towards the boundary of the input color gamut, especially in the manner in which the input color gamut and the output color gamut are different in the respective color value range. Thus, the first color values which lie in the interior of the input color gamut and in the vicinity of the boundary of the input color gamut are preferably mapped onto a second color value which lies within the output color gamut and is again as close to the boundary of the output color gamut.

As described above, a plastic deformation of the input color gamut through the reference color gamut to the output color gamut is preferred. Expressed differently, the neighboring relations are preferably maintained, whereby preferably the change of the distances of neighboring color values by the mapping becomes correspondingly larger, or are possibly even compressed, the closer the color values are to the boundary of the color gamut and/or the more different the output gamut is from the input gamut in this color value range.

When reference is made in this application to distances between color values or within a color space, this refers especially to color distances as defined according to the CIE standard which relate especially to the human color perception.

For example, the CIE LAB color space is a color space which is adapted to the color sensitivity of the human eye. In the CIE LAB color space, each color pair which is separated by a euclytic distance 1 appears equally spaced from one another to a human observer. A trained observer is under ideal conditions in the position to distinguish color up to about

ΔE=[(ΔL²+Δα²+Δβ²)]^{1/2}=1

The first mapping within the reference color space is preferably designed so that an input transformation encompassing the mapping is preferably constant. The first derivative of the input transformation is preferably also constant and especially does not become singular. This should also apply for the relevant value (i.e. the first color values within the input color gamut and second color values within the reference gamut).

The second mapping within the reference color space is preferably designed so that the output transformation encompassing the second mapping is preferably constant. Preferably, the first derivative of the output transformation is also constant and especially does not become singular. This applies preferably at least for the relevant value space (i.e. the second color values within the reference gamut and the third color values within the output color gamut).

The reference color gamut is preferably designed such that it encompasses not only the input color gamut of an input device but of a plurality of input devices. Image data which originate from a plurality of input devices can thereby be processed according to the process of the invention for the color management of image data. The reference color gamut preferably encompasses the output color gamuts of a plurality of output devices. A flexible color management for a plurality of output devices can thereby be achieved. Thus, the image data of a plurality of input devices with different color gamuts can with the process of the invention be preferably flexibly adapted to a respectively desired output device of a plurality of output devices.

The first mapping and the second mapping within a reference color space are preferably designed so that the first, second and third color values have the same or at least a (very) similar hue. Thus, only a translation occurs within a color plane in the reference color space on which the hue is constant. An essential aspect of the color information is thereby maintained, while the dynamic of the output device, for example with respect to brightness and/or color saturation, can be used fully.

When manipulations of the color values are carried out, especially local manipulations, which affect the color values in portions of the image i.e. locally, they are preferably carried out in the reference color space, preferably based on the reference positions and preferably under consideration of the reference gamut. Based on the manipulated reference positions the image control data are then determined, for example according to one of the above-described processes. This has the advantage that the manipulation processes can be used independent of the input device and the output device. The manipulation processes include especially processes for the local darkening and/or brightening of an image, processes which are based on image content recognition, such as for example, processes for the removal of red eye effect, and processes which are based on the recognition of “memory colors”, such as, for example, skin color. Generally, processes are especially included which are directed to local changes of the image properties within the image, such as, for example, local sharpness changes, local color value change, local brightness change, and so on.

The present invention relates especially to a program which when carried out on a computer or on a data processing unit, causes the computer or the data processing unit to carry out the process. The invention especially relates also to a computer storage medium, such as, for example, a CD, DVD diskette, and so on, which stores the above mentioned process or includes information corresponding to the program. Furthermore, the present invention relates to a signal wave, which contains and/or transports the aforementioned program as information, especially a signal wave which represents a transmission of the program through a network, for example the internet.

The invention further relates to a computer on which the aforementioned program is stored.

The invention relates also to a photographic printer which, for example, operates with photographic papers (for example a DMD photographic printer) color printers, such as, for example, inkjet color printers or laser color printers, or a photolab, especially a minilab, i.e. a lab with an especially small floor surface of only a few square metres or less than one square metre or also a large lab. The aforementioned photographic printer, color printer or the so-called photolab includes especially a unit for the receiving of the image data. This unit is, for example, an interface for the receiving of data from a network, especially the internet, a memory read-out unit, such as, for example, a CD reader or a memory card reader, in order to read the storage media on which the image data (photographic images) are stored. Furthermore, a data processing unit is especially a computer, a mother-board with CPU or a CPU or an ASIC. This data processing unit processes the image data received according to the process in accordance with the invention in order to obtain the image control data for the control of an output device, especially an image reproduction system, especially an image recording system. The image recording system is especially an exposure unit for the exposure of a light sensitive photographic paper according to the image control data, a color printer, especially an inkjet printer or a toner printer, for the generation of the photographic image on a medium, especially paper or foil.

The invention also relates to input devices, for example film scanner, and output devices, for example photographic prints which are spatially separated and connected through a network (for example CAN or internet). The transmission of the image data is preferably carried out as reference positions in the reference color space. The invention also relates to a system of input and output devices, which are connected, for example, through a network, whereby the system uses the process in accordance with the invention. In particular, the present invention relates to a device, (input device and/or output device) and/or process for the storage and/or reading and/or receiving, sending of data which represent the reference positions produced in accordance with the invention. This process or device should be constructed especially for use in the aforementioned system, whereby the input device represents the left half in FIG. 2 and the output device the right half in FIG. 2 and the two devices communicate with one another (for example through a network or data carrier) by way of the reference positions (or data which represent the reference positions). The input device thus produces according to the process of the invention the reference positions from the image data and the output device produces from the reference positions the image control data according to the process of the invention. The input device preferably includes at least one input device, a data processing device to convert the received image data into reference data according to the process of the invention, which reference data represent the reference positions, and a data storage device for the storing of the reference data onto a data carrier and/or a reference data send interface. The output device includes preferably a reference data reader device for the reading of the reference data from the data carrier and/or a reference data receiver interface, a data processing device for determining the image control data in accordance with the process of the invention from the reference data received, and an output device which is controllable by the image control data.

### BRIEF DESCRIPTION OF THE DRAWINGS

Further features and advantages of the invention will be apparent from the following detailed description. Different features of different embodiments can be combined with one another.

FIG. 1 shows the coupling of different input devices with different output devices through a color space platform according to an exemplary process of the invention;

FIG. 2 shows an exemplary color management process of the invention;

FIG. 3 shows an sRGB color gamut and a photo paper gamut in an exemplary second color space;

FIG. 4 shows the course of an exemplary weighting function which is used in the generation of the reference positions;

FIG. 5 shows an exemplary mapping in the second color space in which the hue is maintained; and

FIG. 6 shows another exemplary mapping function for obtaining the reference positions.

### DETAILED DESCRIPTION OF THE PREFERRED EMBODIMENTS

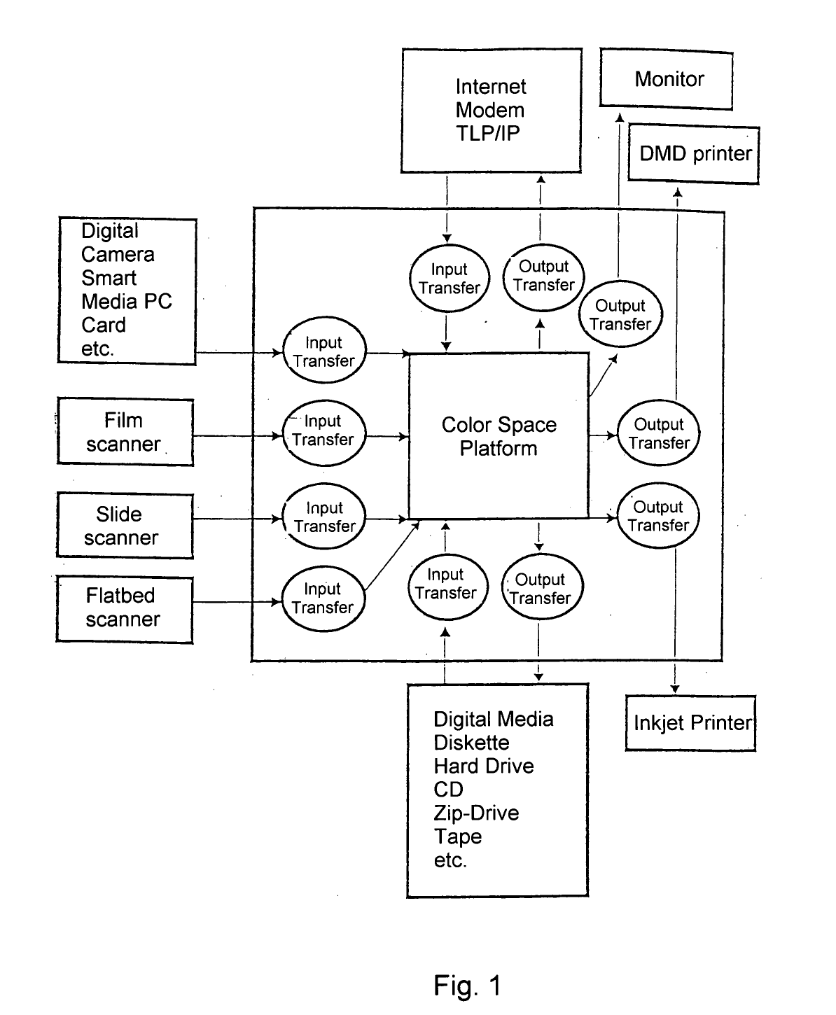

FIG. 1 shows a networking of input devices and output devices through a color space platform. A desired color space or standard space is used as color space platform which was referred to above as reference color space. The reference color space is preferably chosen to be a CIE color space, for example, a CIE LAB color space or a CIE XYZ color space, as are common in today's color management systems. That color space has the desired properties that it is independent of the type of the input device or output device and that it encompasses the color spaces of all possible input devices and output devices. When the received image data are reproduced in the reference color space, for example by transforming them into the reference color space, if they are not already present in the reference color space, one discovers that the color values (first color values) represented by the image data are not completely independent of the type of the device, since they are limited with respect to the capturable colors (for example camera or film scanner). In other words, the first color values disclose the properties of the input gamut of the input devices. The reference color space is preferably designed such that it assigns each color value an individual well defined position or a single point in the color space. Defined transformations preferably exist between the first and the reference color space and especially between the reference color space and the third color space. Output devices are especially image reproduction systems, such as pigment systems (photographic printer or color printer), monitors, storage media or network interfaces.

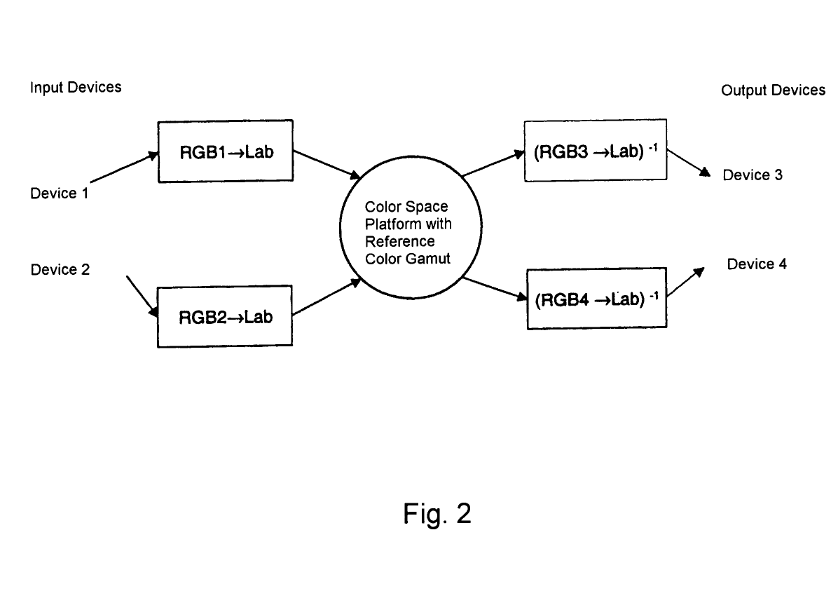

FIG. 2 shows an exemplary color management of the invention from the view of the color spaces. The input devices are defined as device 1 and device 2. The device 1 is, for example, a digital camera, which outputs the color data in the form of the sRGB format. The device 2 is, for example, a scanner which scans a film negative and outputs the data as RGB data. The image data output by the device 1 are referred to as RGB1 and the image data output by the device 2 are referred to as RGB2. The RGB1 and RGB2 data are respectively present in their own color space. They are transformed into the reference color space by an exemplary process of the invention. That is a CIE LAB color space in the example illustrated in FIG. 2. Within this reference color space, the transformed image data now mirror the input gamut of the device 1 or device 2. In other words, all possible input transformation positions span in the second color space the input color gamut of the input device. A special idea of the process of the invention now resides in that this limitation which is placed on the input transformation positions is overcome by a mapping (first mapping) which maps the space of the possible color values into the reference gamut. In this manner, properties of the input device (color properties) are removed or at least attenuated. Analogously, the output transformation positions of the output devices 3 and 4 define the output color gamut of device 3 and 4 in a reference color space. The mapping (second mapping) of the output transformation again forms a rule for the mapping of the second positions onto the output color gamut of the devices 3 and 4. The color values are then imaged into the device dependent color space RGB3 and RGB4. In this manner, properties of the output device (color properties) are considered in such a way that the color reproduction is optimal within the realm of possibilities. Thus, the reference color space and the first mapping belonging to each input device as well as the second mapping belonging to each output device leads to a mediation between the input device and the output device. A high flexibility with a high range of use is achieved in that several input devices and therefore several color gamuts and several output devices and therefore several output color gamuts are linked through the color space platform.

A bijective transformation from the input device color value (first positions) to the reference color value (second positions), i.e. a transformation which is invertible, is preferably defined for each input device.

A bijective transformation of the reference color value (second positions) to the output color device value (third positions), i.e. a transformation which is invertible for each color value, is preferably defined for each output device.

The input transformation from the first color space into the reference color space is preferably colorimetrically exact, when the color values are spaced far from the gamut boundary. The input transformation is preferably carried out from RGB to CIE LAB. The colors on the gamut boundary, for example the RGB cube surface are preferably mapped by the input transformation from the surface of the RGB color cube onto that of the reference color gamut. Colors in the vicinity of the gamut boundary are preferably deformed similar to a plastic deformation, whereby neighboring color values always remain neighboring color values. The first derivation of the transformation should not become singular in order to achieve a bijective property of the transformation. For numeric reasons, the first derivations should remain within the preselected range of values.

The reference positions are preferably directly calculated by way of an IGB-CIELab transformation. The image control data which represent the third positions are preferably calculated in that first an RGB-CIELab transformation is calculated which is then inverted.

Exemplary advantages of the invention reside especially in that no or at least very little gamut mapping need be carried out which can lead to a loss of color details and to numeric problems at the gamut boundaries. Furthermore, the transformation for each color value can be inverted. Finally, no color information is lost.

A series of color value changes, which correspond, for example, to mapping within the second color space, are possible. For example, the size of the inner region of the reference color gamut for which no color value change should occur, can be varied. With respect to the color value change, i.e. with respect especially to the color values which are located at the boundary of the gamut, different processes are possible, for example, the weighting can be varied for maintaining or changing the color hue components, color saturation components or brightness components.

The reference color gamut can be selected in many different ways. For example, the gamut can be selected from XYZ, the gamut of sRGB, the gamut of a typical output device, or even a geometrically well defined gamut (for example a sphere). However, the volume of the reference gamut should be about the same size or larger than the volume of the input and output color gamuts.

During the processing of the image data, the chain of transformations (first color space transformation, first mapping, second mapping, second color space transformation) can be carried out step by step, one transformation after the other. The chain of transformations can be carried out in the mentioned sequence as well as in the opposite direction (reverse sequence) depending on the desire and goal. Preferably, two, three or four neighboring transformations can also be combined into one transformation in order to subject the image to fewer transformations, which allows a faster processing. Especially, the input transformation (first color space transformation and first mapping) can be combined with the output transformation (second mapping and second color space transformation) into a single transformation.

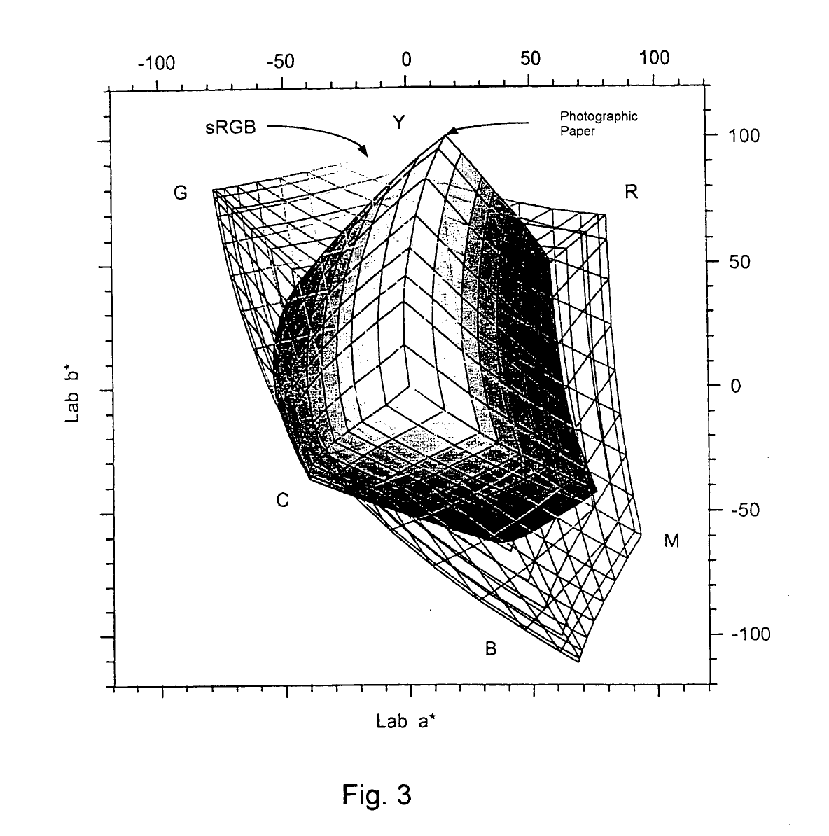

FIG. 3 shows as input color gamut in the second color space the gamut of the sRGB as well as output color gamut the gamut of the photographic paper. As is apparent, the two gamuts have large regions of overlap. However, parts of the sRGB gamut lie outside of the photographic paper gamut and vice-versa. In accordance with the invention, the reference color gamut therefore includes the sRGB gamut as well as the photographic paper gamut.

In the following, a combination of the gamut of the photographic paper with the sRGB gamut of the reference color gamut is used as a first example. For that purpose, a transformation from a paper RGB color space into the CIELAB color space is preferably defined, this can be carried out by a simple grid or a mesh, which, for example, has the dimension 65×65×65. Intermediate points are defined by linear interpolation. Alternatively, a mathematically defined function can be used. For each color triplet of RGB, a corresponding CIELAB triplet exists, which is referred to as Lab_{pRGB}. The calculation of the CIELAB triplet from the RGB triplets is described in the following.

In the example described, sRGB is used as an example for representing the colors of the input device. The standard formula can therefore then be used to carry out a transformation from sRGB to CIE LAB. RGB color spaces other than the sRGB color space can also be used. However, transformations from this color space into the second color space (for example CIELAB) are preferably known.

The transformation can be defined as follows, for example, whereby Lab stands for a value triplet:

Lab_{weighted}=(1-_{WRGB})·Lab_{sRGB}+_{WRGB}·Lab_{pRGB}

The weighting W_{RGB} is a function of the nearest distance d_{RGB} of an sRGB datum (first position) to the sRGB surface. W_{RGB}=1 for colors on the surface of the RGB cube and W_{RGB}=0 in the center of the RGB cube. The distance d is standardized to 1 if it refers to the distance of the surface of the cube to the center of the cube.

A typical weighting function is as follows:

$${W}_{i} = if [ {d}_{i} > cutOff , [ 1 - {cos [ \frac{π}{2 \cdot ( 1 - cutOff )} \cdot ( {d}_{i} - cutOff ) ]}^{2} ] , 0 ]$$

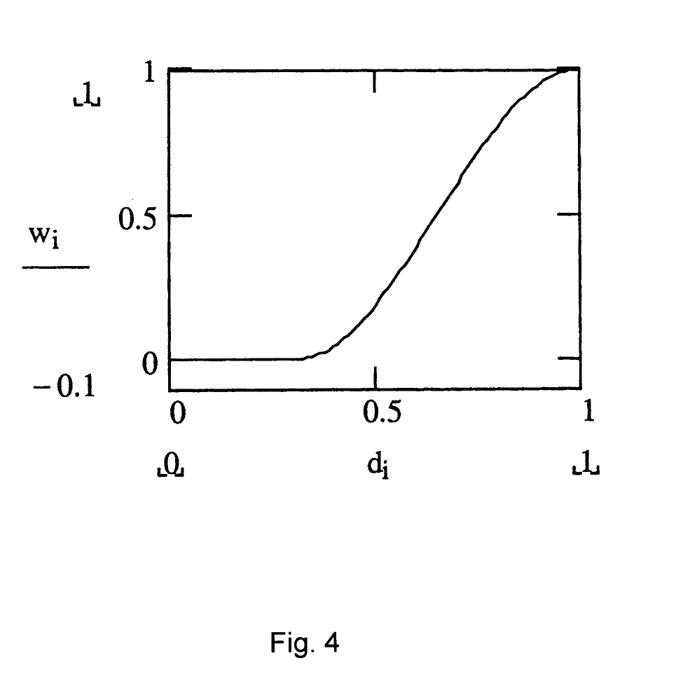

The Wᵢ used in the above formula is, for example, W_{RGB} and the above dᵢ is, for example, the d_{RGB} and “i” refers to the i-th sRGB datum. The course of Wᵢ is shown in FIG. 4 as a function of dᵢ. As is apparent, the “plastic deformation” in the vicinity of the center is almost not present or only present very little in the vicinity of the center and then decreases outwardly from about 30% of the maximum distance. Thus, for large distances, the influence of the output reference gamut increases with increasing distance, whereby the influence of the input reference gamut increases with increasing distance but prevails at least for small distances.

Other weighting functions which will fill the following conditions will also be suitable:

wᵢ=1, 0 on the surface;

wᵢ=0,0 in the center of the cube;

wᵢ increases monotonously;

the first derivative of wᵢ for dᵢ is not singular for all 0 to dᵢ 1 and especially within a preselected value range which is suitable for a (preselected) numeric processing.

An example is described in the following in which the reference gamut covers the whole XYZ gamut.

The gamut of the XYZ includes all possible colors. The transformation is described in three steps:

The transformation is carried out from CIELAB to XYZ according to a standard formula. If the input data are not yet present in the CIELAB form, a transformation from CIELAB to XYZ is carried out as described, for example, in the preceding example. The XYZ values resulting from this transformation of Lₛₐₘₚₗₑ- values are referred to as xyzₛₐₘₚₗₑ.

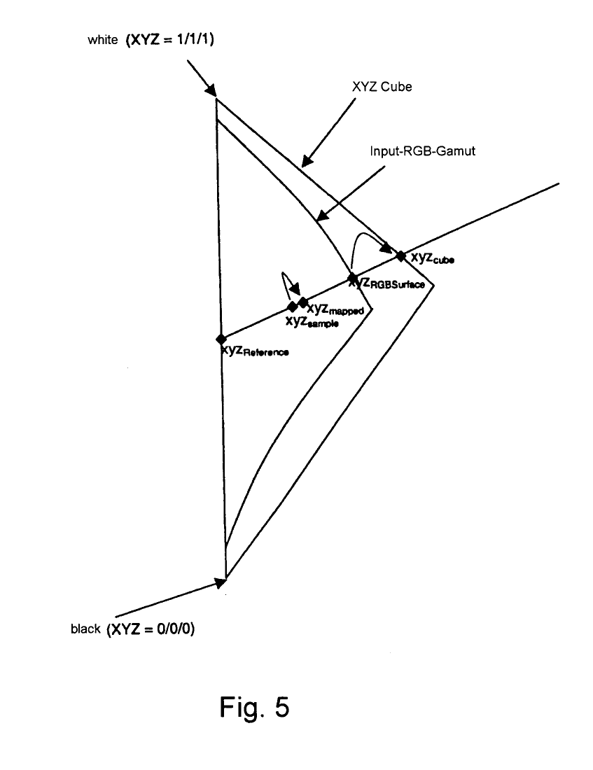

Subsequently, the xyzₛₐₘₚₗₑ values are transformed into xyz_{mapped} values whereby the color hue is maintained. Within the XYZ semi-planes which include the grade axis (x, x, x) with x=0 . . . 1, all colors are described which include a certain color hue. FIG. 5 shows such a semi-plane which includes this gray axis. All color values in the semi-plane illustrated in FIG. 5 which do not lie on the gray axis have the same color hue.

As a third step, a transformation back into the CIELAB color space is carried out according to a standard formula. The xyz_{mapped} values are thereby transformed into L_{mapped} values.

In summary, the transformation xyzₛₐₘₚₗₑ to xyz_{mapped} is described in semi-planes with constant color hue. A straight line can be defined for each color value with the position xyzₛₐₘₚₗₑ which goes through two points. The one point is referred to as reference point xyz_{reference} (for example 0.5, 0.5, 0.5) and the other is referred to as xyzₛₐₘₚₗₑ. This line crosses the input color gamut (RGB gamut) at the point xyz_{RGB-Surface} and the XYZ cube at xyz_{cube}.

The mapping function: xyz_{mapped}=f(xyzₛₐₘₚₗₑ) applies for all points on the straight line. This function can be defined with the following marginal conditions: xyz_{RGB-surface} is mapped onto xyz_{cube} and all points in the vicinity of xyz_{reference} can remain unchanged. Furthermore, as mentioned above, the color hue should remain unchanged, which is ensured a priori in that all colored translations are carried out within the semi-plane.

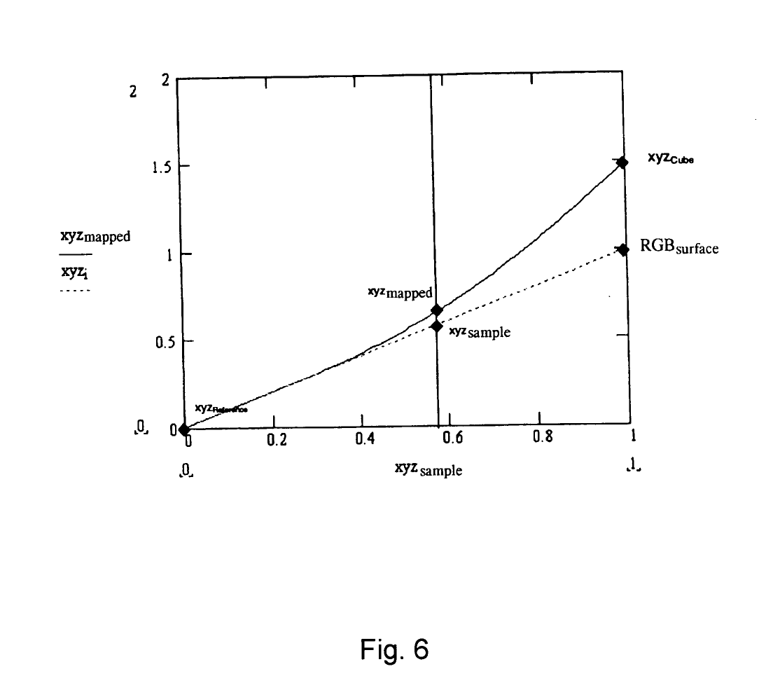

FIG. 6 illustrates an exemplary mapping function for f. The continuous line marks the course of the function f depending on xyzₛₐₘₚₗₑ. The broken line marks the case of a 1:1-mapping, which means xyzₛₐₘₚₗₑ=xyz_{mapped}, which is the case when in the respective direction the input RGB gamut is equal to the reference gamut.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. Process for color management of image data which represent color values of an image to achieve an optimal change of the color values with respect to different and preselected color gamuts of an input device, and an output device, whereby an input color gamut includes all color values which can be captured by the input device and output as image data, and whereby an output color gamut includes all color values which can be processed by the output device upon input of image control data into the output device, the process comprising:
a) receiving image data which represent first positions in a first color space and describe first color values, which are located within the input color gamut;
b) transforming the first positions by an input transformation into reference positions, whereby the transformation is designed such that the reference positions are located in a second color space and describe second color values, whereby a reference color gamut defines the color values reproducible by the reference positions;
c) transforming the reference positions by an output transformation into third positions, whereby the output transformation is designed such that the third positions are located in a third color space and describe third color values which are included by the output color gamut of the output device.

2. Process according to claim 1, wherein the input transformation is designed such that
a) the second color values are at least essentially the same as the first color values, when the color values are around a medium gray or in its vicinity and/or when the first and/or second color values are in the inner region of the input color gamut and/or the reference color gamut, spaced from a boundary surface of the input color gamut and/or reference color gamut; and/or
b) the first color values which lie on the boundary surface of the input color gamut are mapped onto second color values lying on a boundary surface of the reference color gamut; and/or
c) neighboring relationships between the color values are maintained, whereby the first color values which are adjacent are mapped into second color values which are also adjacent; and/or
d) a first derivation of the input transformation does not become singular and/or the input transformation is bijectiv.

3. Process according to claim 1, wherein the output transformation is designed such that
a) the third color values are at least essentially the same as the second color values, when the color values are around a medium gray or in its vicinity and/or when the second and/or third color values are in an inner region of the output color gamut and/or the reference color gamut, spaced from a boundary surface of the output color gamut and/or reference color gamut; and/or
b) the second color values which lie on the boundary surface of the reference color gamut are mapped onto third color values lying on the boundary surface of the output color gamut; and/or
c) neighboring relationships between the color values are maintained, whereby second color values which are adjacent are mapped into third color values which are also adjacent; and/or
d) a first derivation of the output transformation does not become singular and/or the input transformation is bijectiv.

4. Process according to claim 1, wherein the reference color gamut includes a plurality of input color gamuts of a plurality of input devices and/or a plurality of output color gamuts or a plurality of output devices.

5. Process according to claim 1, wherein the input and/or output transformations are designed such that at least a portion of the second color values has a same hue as at least a portion of the first and/or third color values.

6. Process according to claim 1, wherein the image data which represent the reference positions in the second color space are optimized before further processing thereof to obtain the image control data.

7. Process according to claim 1, wherein the input transformation and the output transformation are combined into one transformation.

8. Program which, when loaded or running on a computer, causes the computer to carry out the process according to claim 1.

9. Computer storage media or computer with a program according to claim 8.

10. Photographic printer, comprising:
a unit for receiving image data;
a data processing unit for processing the image data received according to the process of claim 1 to obtain image control data;
an image reproduction system for producing a photographic image based on the image control data on a recording medium.

11. Process according to claim 1, wherein the input device is a film scanner or digital camera.

12. Process according to claim 1, wherein the output device is a photographic printer or fotolab.

13. Photographic printer according to claim 10, wherein the recording medium is paper or photographic paper.
